(19) United States
(12) Patent Application Publication
(10) Pub. No.: US 2011/0072614 A1
(43) Pub. Date: Mar. 31, 2011

(54) SHOWER DOOR ROLL WHEEL ASSEMBLY

(75) Inventor: Craig Luedke, Hot Springs, AR (US)

(73) Assignee: SAPA Extrusions, INC., Moon Township, PA (US)

(21) Appl. No.: 12/568,482

(22) Filed: Sep. 28, 2009

(51) Int. Cl. E05D 15/14; B23P 17/04

(52) U.S. Cl. 16/97; 29/428

(57) ABSTRACT

Apparatus including shower door roll wheel assemblies and methods of using the same are provided. In one embodiment, a shower door roll wheel assembly includes a shaft, a roll wheel and an outer flange. The roll wheel includes a passageway disposed through the body of the roll wheel. The roll wheel is configured to rotate on the shaft about an axis of the passageway. The roll wheel includes a tread configured to engage a track of a shower door track. The roll wheel may include multiple polymeric materials to facilitate tailored durability and noise reduction, among other properties.

### BACKGROUND

Showers generally spray water, and thus are generally enclosed via an enclosure, such as via a shower curtain or rigid shower doors. Current shower door assemblies may be problematic to install and/or produce a large amount of noise during movement.

### SUMMARY OF THE DISCLOSURE

Broadly, the present disclosure relates to new shower door roll wheel assemblies, methods of coupling such assemblies to shower door mounts, and related technology. In one aspect, an apparatus includes (a) a shower door roll wheel assembly and (b) a coupling member configure to couple the shower door roll wheel assembly to a shower door mount.

In one approach, a shower door roll wheel assembly includes a shaft, a roll wheel, and a first (e.g., outer) flange. The roll wheel has a body having a first face, a second face, and a hub having a passageway disposed through the body. The roll wheel may be configured to rotate about an axis of the passageway. The axis of the passageway may be transverse to the first and/or second face of the body. The first face may be proximal a first end of the shaft. The second face may be proximal a second end of the shaft. The roll wheel may have a tread configured to engage a track of a shower door track.

The outer flange of the assembly may be coupled to the first end of the shaft. In one embodiment, the outer flange at least partially assists in restricting side-to-side movement of the roll wheel. For example, when the shower door roll wheel assembly is coupled to the coupling member and when the first flange is coupled to the first end of the shaft, the first flange and a side of the shower door mount may restrict side-to-side movement of the roll wheel. In one embodiment, the outer flange may be repeatedly coupled to and disengaged from the first end of the shaft. Thus, old roll wheels may be readily removed from the assembly, and new roll wheels may be readily installed in the assembly.

In one embodiment, a first portion of the roll wheel comprises a first polymeric material and a second portion of the roll wheel comprises a second polymeric material, wherein the first polymeric material is different than the second polymeric material. Due to the use of different polymeric materials, tailored properties of the roll wheel may be realized. For example, harder polymeric materials may be used where durability is a priority. Softer polymeric materials may be used where noise reduction is a priority. Self-lubricating polymeric materials may be used where low friction is a priority. In one embodiment, at least a portion of the hub of the roll wheel comprise a first polymeric material, and at least a portion of the tread of the roll wheel comprises a second polymeric material. In one embodiment, the entire hub comprises a first polymeric material. In one embodiment, the entire tread of the roll wheel comprises a second polymeric material.

In one embodiment, the first polymeric material is durable and/or self-lubricating. In one embodiment, the first polymeric material comprises or consists essentially of nylon. In one embodiment, the second polymeric material is soft and/or energy absorbent. In one embodiment, the second polymeric material comprises or consists essentially of urethane. In one embodiment, the first polymeric material has a shore hardness that is greater than that of the second polymeric material as measured in accordance with ASTM D2240. Shore hardness, using either the Shore A or Shore D scale, is the preferred method for rubbers/elastomers and is also commonly used for ‘softer’ plastics such as polyolefins, fluoropolymers, and urethanes. The Shore A scale may be used for ‘softer’ rubbers while the Shore D scale may be used for ‘harder’ ones.

In one embodiment, the roll wheel is a multi-piece roll wheel, and a first piece of the roll wheel comprises the first polymeric material, and a second piece of the roll wheel comprises the second polymeric material. In one embodiment, the first piece is a ring-shaped solid and includes at least a portion of the hub. In one embodiment, the first piece includes the entire hub. In one embodiment, at least one tab extends from an outer surface of the ring-shaped solid. In one embodiment, one or more tabs are located proximal an end portion of the ring-shaped solid.

In one embodiment, the second piece of the roll wheel is coupled to the first piece. In one embodiment, the second piece includes at least a portion of the tread. In one embodiment, the second piece includes the entire tread. In one embodiment, the second piece is injection molded onto the first piece. In one embodiment, the first and second pieces are integral. In one embodiment, the second piece includes at least one slot. One or more of these slots of the second piece may be configured to restrictively engage each tab of the first piece. In one embodiment, the arrangement of the tabs and/or slots facilitates a non-slip arrangement between the first piece and the second piece. For example, the tabs/slots may restrict/prevent the first piece from slipping during the rotational movement of the tread of the second piece. In one embodiment, the first face of the roll wheel comprises an extension. In one embodiment, this extension includes at least a portion of a tab of the first piece.

In one embodiment, the assembly includes first and second flanges. In this embodiment, the second flange may be the outer flange and the first flange may be an inner flange. The first flange may be located proximal a first end of the shaft. The first flange may be located adjacent the first (e.g., inner) face of the roll wheel. The second flange may be located proximal a second end of the shaft. The second flange may be located adjacent a second (e.g., outer) face of the roll wheel. In one embodiment, the first flange may be integral with the shaft and the second flange may be non-integral with the shaft. In one embodiment, the second flange may be configured to be coupled to or interlocked to the second end of the shaft. In one embodiment, when the roll wheel is located on the shaft and when the second flange is coupled to or interlocked to the second end of the shaft, the first flange and the second flange restrict side-to-side movement of the roll wheel.

The coupling member is configured to couple the shower door roll wheel assembly to the shower door mount. In one embodiment, the coupling member is configured to couple the shower door roll wheel assembly to the shower door mount via the shaft. In one embodiment, the shaft comprises one of a male fitting and female fitting, and the coupling member comprises the other of the male fitting and the female fitting. In one embodiment, the coupling member is configured to couple the shower door roll wheel assembly to the shower door mount via interconnection of the male fitting to the female fitting. In one embodiment, the male fitting and the female fitting are threaded.

Methods for installing shower doors are also provided. In one embodiment, a method includes the steps of (a) fixing a shaft to a shower door mount, (b) placing a roll wheel on the shaft, and (c) interlocking the roll wheel to the shaft. In one embodiment, after the interlocking step, a passageway of the roll wheel rotatably engages the shaft and side-to-side movement of the roll wheel is restricted. In one embodiment, both the placing step and the interlocking step occur before the fixing step. In one embodiment, the interlocking step includes interlocking a flange to an end of the shaft.

In one embodiment, the fixing step includes coupling a coupling member to at least a portion of the shaft. In one embodiment, after the coupling, a flange of the coupling member is located on a first side of the shower door mount and a flange associated with the shaft is located on a second side of the shower door mount.

In one embodiment, at least a portion of the roll wheel comprises urethane. In one embodiment, the method includes moving a shower door associated with the shower door mount from a first position to a second position. In one embodiment, during the moving step, the portion of the roll wheel comprising urethane absorbs energy associated with the moving step, thereby facilitating low noise emissions. In one embodiment, the low noise emissions are perceptibly less than the noise emissions of a comparable conventional nylon roll wheel.

Various ones of the inventive aspect, approaches, and embodiments described above may be combined to yield various shower door roll wheel assemblies, coupling members and related apparatus for installing shower doors.

### BRIEF DESCRIPTION OF THE DRAWINGS

FIG. 1a is a first perspective, exploded view of an embodiment of a shower door roll wheel assembly and a coupling member in accordance with the present disclosure.

FIG. 1b is a second perspective, exploded view of the apparatus of FIG. 1a.

FIG. 2 is a cross-sectional view of the apparatus of FIGS. 1a and 1b in partial coupled form.

FIG. 3a is a perspective view of the apparatus of FIGS. 1a-1b connected to a shower door mount.

FIG. 3b is another perspective view of the apparatus of FIGS. 1a and 1b connected to a shower door mount.

FIG. 3c is a side view of the apparatus of FIGS. 1a and 1b connected to a shower door mount.

FIG. 4a is a cross-sectional, side view of a first member of the shower door roll wheel assembly of FIGS. 1a and 1b.

FIG. 4b is a perspective view of a first member of the shower door roll wheel assembly of FIGS. 1a and 1b.

FIG. 5a is a side view of the roll wheel of the shower door roll wheel assembly of FIGS. 1a and 1b.

FIG. 5b is a perspective view of the roll wheel of the shower door roll wheel assembly of FIGS. 1a and 1b.

FIG. 6a is a perspective view of one embodiment of a first piece of a two-piece roll wheel.

FIG. 6b is a perspective view of a composite roll wheel containing the first piece of FIG. 6a.

FIG. 7 is a perspective view of another embodiment of a first piece of a two-piece roll wheel.

FIG. 8 is an exploded, perspective view of another embodiment of a shower door roll wheel assembly and a coupling member.

FIG. 9 is a cross-sectional side view of the apparatus of FIG. 8 in coupled form.

FIG. 10 is a perspective view of another embodiment of a shower door roll wheel.

FIG. 11a is a perspective view of another embodiment of a first member of a shower door roll wheel assembly.

FIG. 11b is a side view of an embodiment of the interconnection of the roll wheel of FIG. 10 with the first member of FIG. 11a.

FIG. 11c is a perspective view of the interconnection of the roll wheel of FIG. 10 with the first member of FIG. 11a.

FIG. 12 is a cross-sectional side view of another embodiment of an interconnection between a roll wheel and a first member.

FIG. 13a is a perspective view of another embodiment of a first member.

FIG. 13b is a side view of the embodiment of FIG. 13a.

FIG. 13c is a perspective view of the interconnection between a roll wheel and the first member of FIG. 13a.

FIG. 14 is a cross-sectional side view of another embodiment of an interconnection between a roll wheel and a first member.

FIG. 15 is a flow diagram illustrating an embodiment of method in accordance with the present disclosure.

### DETAILED DESCRIPTION

Reference will now be made in detail to the accompanying drawings, which at least assist in illustrating various pertinent embodiments of the present invention.

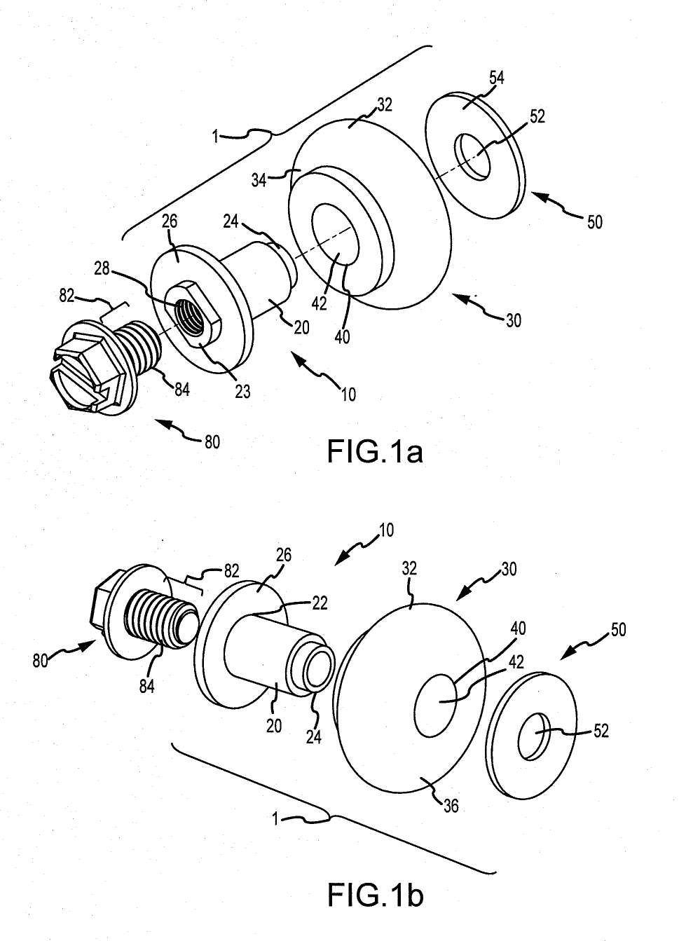

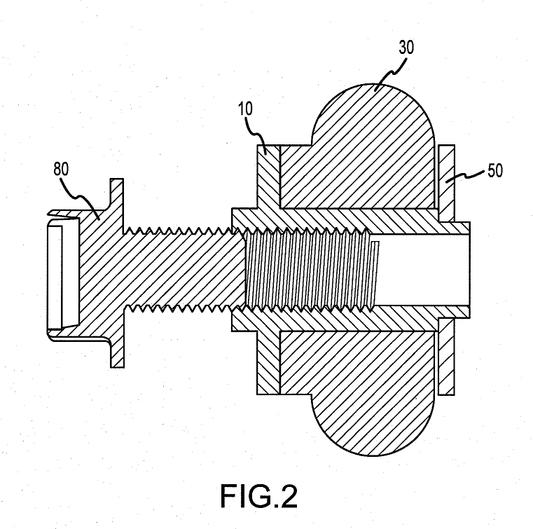

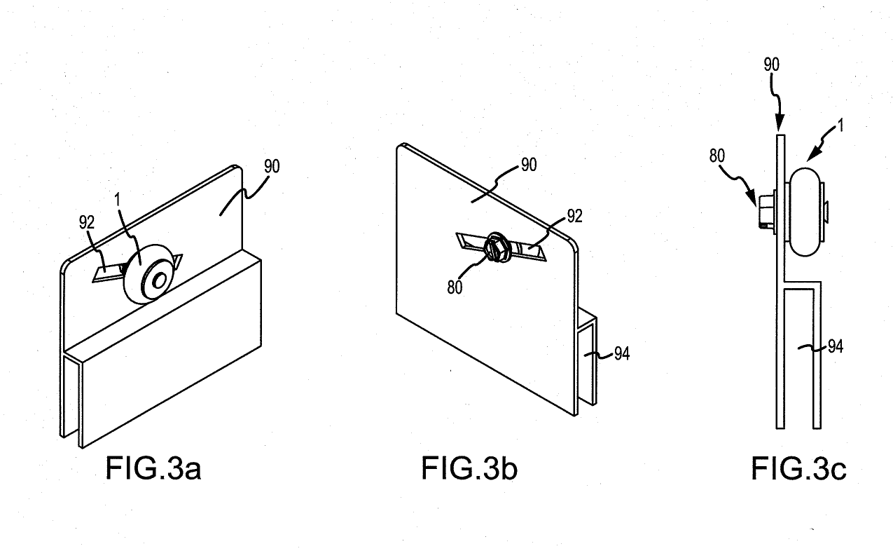

FIGS. 1a, 1b and 2, illustrate one embodiment of an apparatus of the present disclosure. In the illustrated embodiment, the apparatus includes a shower door roll wheel assembly 1 and a coupling member 80 for coupling the shower door roll wheel assembly 1 to a shower door mount 90 (FIGS. 3a-3c). In the illustrated embodiment, the shower door roll wheel assembly 1 includes a first member 10, a roll wheel 30, and an outer flange member 50. The first member includes a shaft 20. The roll wheel 30 includes a hub portion 40 having a passageway 42. As assembled, the roll wheel 30 rotates about the hub 40 and shaft 20. The hub 40 may be constructed of polymeric materials, as described in further detail below. The use of such polymeric materials may facilitate energy absorption during the movement of the roll wheel 30, and thus facilitate low or inaudible noise emissions. In one embodiment, the hub 40 is made of nylon.

The roll wheel 30 also includes a tread 32. As described in further detail below, this tread 32 is configured to engage a track of a shower door track. The tread 32 of the roll wheel 30 may be made of a polymeric material, which may be the same polymeric material or a different polymeric material than that of the hub 40. The use of a tread 32 comprising a polymeric material may facilitate energy absorption during movement of the roll wheel 30 within a track of the shower door track (e.g. due to imperfections in the track), and thus facilitate low or inaudible noise emissions. In one embodiment, the tread 32 is made of a urethane.

In the illustrated embodiment, the roll wheel 30 is maintained on the shaft 20 via a first flange 26 and the outer flange 50 (sometimes referred to herein as the second flange 50). The first flange 26, which in this instance is integral with a first end 22 of the shaft 20, may be located proximal (e.g., adjacent to) a first face 34 of the roll wheel 30 when the roll wheel 30 is engaged with the shaft 20. In the illustrated embodiment, a face 54 of the second flange 50 is located proximal (e.g., adjacent to) a second face 36 of the roll wheel 30. In one embodiment, the second flange 50 is interlocked with the second end 24 of the shaft 20 via hole 52 when the roll wheel 30 is engaged with the shaft 20. This interlocking may be realized via flaring of the second end 24 of the shaft 20. In other embodiments, the second flange 50 may be coupled to the second end 24 of the shaft, such as via the use of threaded members (e.g., a screw-nut arrangement). Thus as assembled, the first and second flanges 26, 50 may restrict the side-to-side movement of the roll wheel 30 as engaged with the shaft 20. In some embodiments, the second flange 50 may be repeatedly interlocked to (or coupled to) and disengaged from the second end 24 of the shaft 20 so as to facilitate repeated assembly and disassembly of the shower door roll wheel assembly 1.

Interlocked means to connect together so that the individual parts affect each other in motion or operation. In some embodiments, interlocked elements are incapable of any substantial movement relative to each other. Couple and the like means to connect. In some embodiments, one object may be coupled to another object, but not in an interlocked fashion. In other embodiments, one object may be coupled to another object, and in an interlocked fashion. Adjacent means near or close to, but not necessarily in contact. In some embodiments, a first object may be adjacent a second object, but not touching the second object. In other embodiments, the first object may be adjacent the second object, and at least partially touching the second object.

Referring now to FIGS. 1a, 1b, 2, and 3, the coupling member 80 is configured to couple the shower door roll wheel assembly 1 to a shower door mount 90. In the illustrated embodiment, the shower door mount 90 includes a slanted window 92 for facilitating interconnection of the coupling member 80 to the shower door roll wheel assembly. As coupled, a flange (e.g., screw head) of the coupling member 80 may engage a first side of the shower door mount 90, and a flange of the shower door roll wheel assembly 1 may engage a second side of the shower door mount. Thus, the shower door roll wheel assembly 1 may be coupled (e.g., fixed) to the shower door mount 90 via the coupling member 80, and at the desired vertical position within the slanted window 92. In other embodiments, the first flange 26 is absent and the fixing of the assembly 1 to the mount 90 is accomplished by configuring the coupling between the assembly 1 and the coupling member 80 in an appropriate manner. For example, the length of the coupling member 80 may be tailored to facilitate fixing of the assembly 1 to the mount 90.

The shower door mount (also known as a shower door bracket) may also include a door holding portion 94 for receiving and/or holding a shower door. The shower door mount 90 may be adapted to both (i) restrictively engage at least a portion of a shower door, and (ii) place at least one roll wheel of a shower door roll wheel assembly in contact with a shower door track. In this manner, as the roll wheel moves from a first position to a second position along the shower door track, the shower door may be positioned from a first position to a second position due to, at least in part, its restrictive engagement with the shower door mount.

A shower is any system having a sprayer for spraying a liquid (e.g., water). A shower may include an enclosure adapted to facilitate containment of sprayed liquid. A shower enclosure may include a shower door assembly. A shower door assembly is an assembly of material configured to facilitate movement of at least one shower door from a first position (e.g., a generally open position) to a second position (e.g., a generally closed position). A shower door assembly may include a shower door, a shower door mount, and a shower door track. A shower door is any material that is suitable for use as a door in a shower. In one embodiment, a shower door is a generally solid piece of material, such as glass (e.g., glass that is translucent, transparent, colored, or otherwise). A shower door track (not illustrated) is a material adapted to engage a tread 32 of a roll wheel 30 of a shower door roll wheel assembly 1, and with the purpose of allowing the roll wheel 30 to move along at least a portion of the length of the shower door track. In one embodiment, the shower door track includes at least one groove for engaging a tread 32 of a roll wheel 30 of a shower door roll wheel assembly 1. A shower door roll wheel assembly is an assembly having at least one roll wheel, and which is configured to facilitate movement of a shower door from a first position to a second position, such as from a generally open position to a generally closed position. For example, a shower door roll wheel assembly may be in at least partially contact with one or more of (i) a shower door mount and (ii) a shower door track, as described above.

In the illustrated embodiment, the first member 10 of the shower door roll wheel assembly 1 includes a female portion 28 configured to engage a male portion 82 of the coupling member 80. In the illustrated embodiment, both the male portion 82 and the female portion 28 include threads for facilitating the coupling of the shower door roll wheel assembly 1 to the shower door mount 90 via the coupling member 80. Other coupling arrangements may be utilized.

In some embodiments, the hub 40 of the roll wheel 30 and the shaft 20 are rotatably engaged. The hub 40 and the roll wheel 30 are rotatably engaged when the clearance between the outer surface of the shaft 20 and the inner surface of the hub 40 is large enough such that the roll wheel 30 can readily rotate about its rotation axis, but the clearance between the outer surface of the shaft 20 and the inner surface of the hub 40 is small enough such that the long axis 44 (FIG. 5a) of the roll wheel 30 generally maintains its position. Generally, the clearance should be sufficiently small so as to prevent wobble of the roll wheel, while also allowing ready rotation of the roll wheel about the shaft. In some embodiments, the clearance is not greater than 0.010 or 0.005 inch.

In the illustrated embodiment, only a single door mount 90 and a single window 92 are illustrated. However, the mount 90 may have multiple windows, each window 92 having an assembly 1 coupled thereto via coupling member 80. For example, a mount 90 may be sized to be coincidental to the size of a shower door. In this embodiment, the mount 90 may have at least two windows 92, with one window 92 and assembly 1 located proximal each end of the mount 90. The mount may also have one or more additional windows 92 and assemblies 1 located in the middle portions of the mount 90. The use of multiple windows 92 and assemblies 1 within a single mount 90 may assist in the movement of and/or the support of the shower door, which may be relatively heavy in some circumstances. In other embodiments, multiple mounts 90 may also be used for a single enclosure for mounting one or more shower doors.

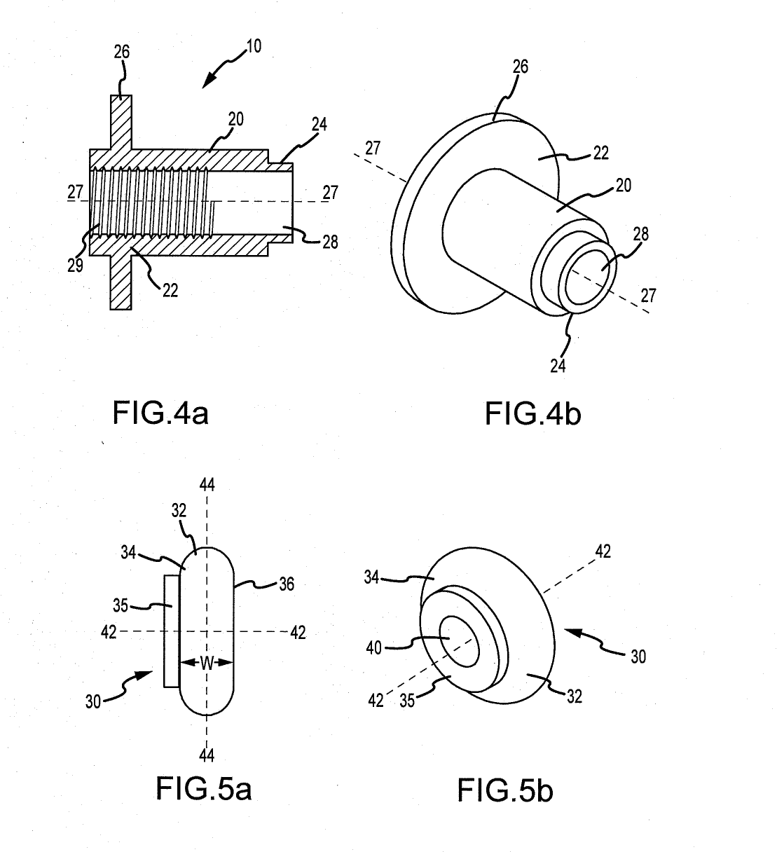

Referring now to FIGS. 1a, 1b, 2, 4a and 4b, the first member 10 generally includes a shaft 20 having a first end 22 and a second end 24. A member means a part of a group. In the illustrated embodiment, the first member 10 is part of the group forming the illustrated apparatus. In the illustrated embodiment, a first flange 26 is located proximal the first end 22 of the shaft 20. In the illustrated embodiment, the first flange 26 is integral with the shaft 20. In this instance, integral is similar to integrated and means formed into or united as a whole. In other embodiments, the first flange 26 may be non-integral with the shaft 20, and may be merely coupled to or interlocked to the first end 22 of the shaft 20. A flange is a protruding rim, edge, rib, collar, or other protrusion used to strengthen an object, hold it in place, or attach it to another object, among other things.

In the illustrated embodiment, the second end 24 of the shaft 20 is configured to interlock the second flange 50 to the shaft 20. In this regard, the second end 24 may include a tapered surface, as illustrated, or other suitable features to facilitate the interlocking of the second end 24 and the second flange 50. For example, after placement of the second flange 50 on the second end 24 of the shaft 20, the second end 24 may be mechanically deformed to interlock the second flange 50 on the second end 24. In other embodiments, the second end 24 and/or second flange 50 may include features that merely allow coupling of the second flange 50 to the shaft 20. In yet other embodiments, the second flange 50 may be integral with the shaft 20. In some embodiments, at least one of the first and second flanges 26, 50 is non-integral with the shaft 20. In other embodiments, both of the first and second flanges 26, 50 are integral with the shaft 20.

The arrangement of the first and second flanges 26, 50 may be such that side-to-side movement of the roll wheel is restricted. To restrict side-to-side movement of the roll wheel means that one or more flanges are located sufficiently proximal one or more faces of the roll wheel such that the long axis 44 of the roll wheel realizes restricted lateral movement while also enabling the roll wheel to readily rotate about a rotation axis. Close proximity between the flange(s) with limited physical contact between the flange(s) and the roll wheel may facilitate restricted side-to-side movement of the roll wheel. In one embodiment, two flanges are located next to two corresponding side faces of the roll wheel, and each flange is located about 0.005 to about 0.010 inch from its corresponding face of the roll wheel. In another embodiment, only an outer flange 50 is used, and the fixing of the assembly 1 to the mount 90 is accomplished by configuring the coupling between the assembly 1 and the coupling member 80 in an appropriate manner. For example, the length of the coupling member 80 may be tailored to facilitate fixing of the assembly 1 to the mount 90.

The shaft 20 is a rod or rod-like structure. The material of the shaft 20 should facilitate rotatable engagement of the hub 40 of the roll wheel 30, while also maintaining the durability of the shaft 20 and the hub 40 of the roll wheel 30. The shaft should have a smooth outer surface so as to facilitate rotation of the roll wheel. In one embodiment, the shaft 20 comprises or consists essentially of a metal material, such as stainless steel, zinc-plated steel, brass, and aluminum, among others. The first flange 26 may be produced from the same or similar material as the shaft 20. When the first flange and the shaft 20 are integral, they comprise the same material.

The first member 10 may include a male or female portion 28 for facilitating interconnection of the shower door roll wheel assembly 1 and the coupling member 80. The coupling member 80 may have the other of a male or female portion relative to the first member 10. In the illustrated embodiment, the first member includes a female portion 28 having threads 29. In the illustrated embodiment, the coupling member 80 has a male portion 82 having corresponding threads 84. In the illustrated embodiment, the female portion 28 is in the form of a passageway that extends completely through the body of the shaft 20 (e.g., all the way through the first end 22 and the second end 24 of the shaft 20). In the illustrated embodiment, the threads 29 extend only partially along the passageway, but in other embodiments the threads 29 may extend the entire length of the passageway. The passageway may have a center axis 27, which may be concentric with an axis 42 of the hub 40 of the roll wheel (FIGS. 5a, 5b).

In other embodiments, the female portion 28 may be in the form of a partial passageway that does not extend all the way through the body of the shaft 20 (e.g., from the first end 22 to a middle portion of the shaft 20). In such embodiments, the threads 29, or other suitable coupling/interlocking mechanism, may extend partially or completely through the partial passageway. Other coupling configurations may be utilized.

The first member 10 may include a projection 23. The projection 23 may be configured to restrictively engage the window 92 of the shower door mount 90 (FIGS. 3a-3c). This restrictive engagement may allow the apparatus to slide laterally along the window but restrict, and in some instances prevent, rotational movement of the shaft of shower door roll wheel assembly. In the illustrated embodiment, the projection 23 is integral with one of the first flange 26 and the shaft 20. In other embodiments, the projection 23 may be non-integral with the first flange 26 and/or the shaft 20.

Referring now to FIGS. 1a, 1b, 2, 5a, and 5b, the shower door roll wheel assembly generally includes a roll wheel 30. A roll wheel is a device adapted to facilitate rotational movement. In one embodiment, at least a portion of the roll wheel 30 is produced from a polymeric material, such as urethane, nylon, vinyl, PVC, elastomer materials, and the like, as described in further detail below. The use of such polymeric materials, especially urethane, may facilitate low noise emissions by the shower door roll wheel assembly during movement of the roll wheel 30. Furthermore, polymeric materials are generally inert to water-containing atmospheres.

In the illustrated embodiment, the roll wheel 30 is a body having a tread 32, a first face 34, a second face 36 (which is opposite the first face 34), and a hub 40. Body and the like means an object having a distinguishable mass. The tread 32 of the roll wheel 30 is configured to engage a track of a shower door track (described above). The tread 32 of the roll wheel 30 may be made of a polymeric material. The use of a polymeric material as the tread may facilitate energy absorption during the movement of the roll wheel 30 within the track of the shower door track (e.g. due to imperfections in the track), and thus facilitate low or inaudible noise emissions. In one embodiment, a tread 32 of the roll wheel 30 is sufficiently soft so as to facilitate noise reduction of a shower roll wheel assembly 1. In some embodiments, the tread 32 of the roll wheel 30 may have a tailored shore hardness as measured in accordance with ASTM D2240. In one embodiment, the tread has a Shore A scale hardness in the range of 40 to 95. In one embodiment, the tread has a Shore A scale hardness in the range of 60-95. In one embodiment, the tread has a Shore D scale hardness in the range of 40-90. In one embodiment, the tread has a Shore D scale hardness in the range of 40 to 60. In one embodiment, the tread is a urethane and has a Shore A scale hardness of about 90. In one embodiment, the tread is a urethane and has a Shore D scale hardness of about 50. Polymeric materials suited for use as the tread include urethanes, elastomers, silicones, vinyls and similar materials. Urethanes include those materials produced from polyurethane resins of ethyl carbamate, which has a chemical formula of CO(NH₂)C₂H₅. In one embodiment, the urethane is polyurethane, which is a thermoplastic polymer that may be produced by the condensation reaction of polyisocyanate and a hydroxyl-containing materials (e.g., a polyol derived from propylene oxide or trichlorobutylene oxide). The basic polymer unit of a polyurethane is formed as follows: R₁NCO+R₂OH→R₁NHCOOR₂. In one embodiment, the tread 32 comprises or consists essentially of urethane.

The roll wheel 30 generally includes a hub 40 having a passageway disposed through the body of the roll wheel 30. The hub 40 is generally configured to rotatably engage a shaft 20 of the shower door roll wheel assembly 1. The hub 40 generally includes an axis 42, which is generally the rotation axis of the roll wheel 30. The axis 42 may be concentric with an axis of the shaft 20. The hub axis 42 is generally transverse to the first and second faces 34, 36 of the roll wheel 30. A long axis 44 of the roll wheel 30 is generally transverse to the hub axis 42. In some embodiments, the long axis 44 may be parallel to at least one face 34, 36 of the roll wheel 30. In some embodiments, the long axis 44 may intersect at or near the center of the width W of the roll wheel 30.

Hub means the central part of a wheel through which a shaft or axle passes. A hub generally has a passageway. Passageway and the like means a path through or along which something may pass. Axis and the like means a straight line through an object. In some embodiments, an axis may be a rotational axis about which a body or geometric object rotates or may be conceived to rotate. Rotate and the like means to turn on an axis. Transverse and the like means non-parallel. Face and the like means a portion of an outer surface of an object.

In one embodiment, at least a portion of the hub 40 of the roll wheel is made up of a polymeric material. The polymeric material of the hub 40 may be the same or different than the polymeric material of the tread 32. Polymeric materials useful relative to the hub 40 include those materials that facilitate rotational movement of the hub 40 of the roll wheel 30 about the shaft 20, but with restricted and/or no degradation of the shaft 20 and/or the hub 40 of the roll wheel 30. It is also useful if the material is naturally lubricating so as to facilitate rotational movement. Polymeric materials suited for this purpose include NYLON, TEFLON, DELRIN, UHMW polyethylenes, polypropylene, and related materials. In one embodiment, at least a portion of the hub 40 comprises or consists essentially of nylon. Nylon means any of a family of synthetic polymers that include the recurring amide group —CONH. Suitable nylon materials for use as the hub include Nylon 66 and Nylon 6, among others. In one embodiment, the hub 40 comprises or consists essentially of a nylon material.

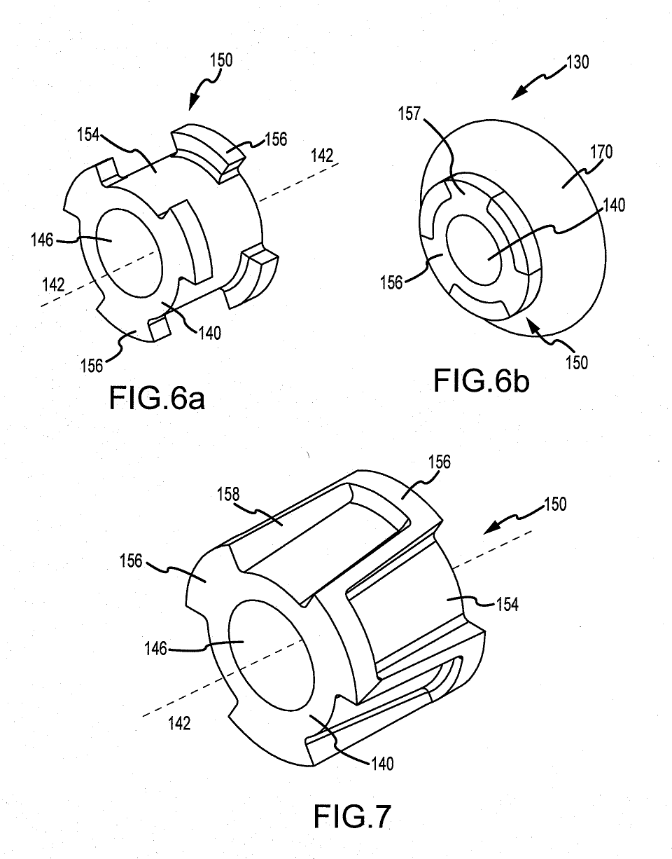

The above-described roll wheel 30 has generally been illustrated as a unitary body. However, in other embodiments the roll wheel 30 may comprise a plurality of pieces. One embodiment of a multi-piece roll wheel is illustrated in FIGS. 6a and 6b. In this embodiment, the roll wheel 130 comprises a ring-shaped first piece 150 and a second piece 170. The ring-shaped first piece 150 comprises a hub 140 having a passageway and an axis 142. The first piece also comprises the inner surface 146 of the hub 140, which is designed to rotatably engage a shaft, as described above. The ring-shaped first piece 150 includes an outer surface 154 having a one or more tabs 156 disposed thereon. In the illustrated embodiment, each of the tabs 156 are located near one of the ends of the ring-shaped first piece 150. In other embodiments, one or more tabs 156 may be located away from the ends of the ring-shaped first piece 150. The tabs 156 are also offset from one another, which may facilitate a non-slip arrangement. The second piece 170 may include a plurality of slots that restrictively engage the tabs 156. Thus, as the roll wheel 130 rotates, little or no slip between the first and second pieces 150, 170 will occur. For example, due to the arrangement of the one or more tabs 156, when a force is placed on the shower door mount (e.g., to move shower door), direct or near-direct translation of energy from the tread to the hub may occur, which may result in low noise emissions, restricted side-to-side movement of the roll wheel, and/or rotatable engagement of the shaft and the hub.

In the illustrated embodiment, the first face includes an extension 157 having some of the tabs 156. This extension 157 may act as a bumper between a flange and/or a side of a shower door mount so as to facilitate restricted side-to-side movement of the roll wheel.

The ring-shaped first piece 150 may be made from a first polymeric material, such as nylon, so as, for example, to facilitate durable construction for use in conjunction with rotatable engagement with a shaft. The second piece 170 may comprise a second polymeric material, such as urethane, which may be injection molded onto the first piece 150, to produce the multi-piece roll wheel 130. The urethane may facilitate low noise emissions of the assembly. Thus, the materials of the multi-piece roll wheel may be tailored to achieve the desired functionality. For example, durability may be tailored via use of nylon and sound emissions may be tailored via use of urethane. The first piece 150 may be considered a plastic bushing that is durable and helps to absorb noise created due to the movement of the roll wheel 130. The first piece 150 may be considered an integral bearing as part of a substructure of the roll wheel 130, creating a precision concentric roller. The use of a separate first piece 150 may facilitate precision in creating a concentric arrangement between the axis of the hub and the axis of the shaft. The hub of the first piece may act as a bearing surface, reducing or eliminating friction and tolerance issues associated with other multi-piece systems. In the illustrated embodiment of FIG. 6b, the first and second pieces are integral (e.g., due to the injection molding of the second piece onto the first piece; due to the use of adhesive).

Another embodiment of a first piece of a multi-piece roll wheel is illustrated in FIG. 7. In the illustrated embodiment, the ring-shaped first piece 150 comprises a hub 140 having a passageway, the axis 142 and the inner surface 146 of the hub 140, as described above. The ring-shaped first piece 150 also comprises the above-described tabs 156, but also includes one or more connection members 158, which are located on the outer surface 154 of the ring-shaped first piece 150 and at least partially connect one tab to one or more other tabs. In the illustrated embodiment, the connection members 158 extend across the outer surface 154 of the first piece 150, and connect tabs 156 located on a first end to tabs 156 located on a second end of the ring-shaped first piece 150.

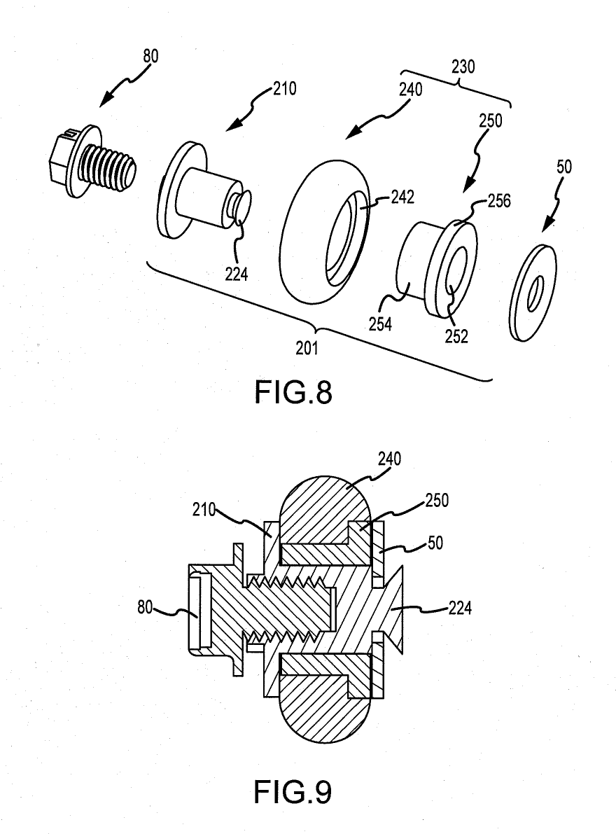

Another embodiment of a multi-piece roll wheel assembly is illustrated in FIGS. 8 and 9. In the illustrated embodiment, the apparatus includes a shower door roll wheel assembly 201 and a coupling member 80. The shower door roll wheel assembly 201 includes a first member 210 having a flanged second end 224 for interlocking with a second flange 50. The shower door roll wheel assembly 201 also includes a roll wheel 230 having a first piece 250 and a second piece 240. The second piece 240 comprises the tread and first face of the roll wheel 230. The second piece 240 may be made from a first polymeric material, such as urethane. The first piece 250 of the roll wheel 230 comprises a hub 254 having a passageway 252 and a portion of the second face of the roll wheel 230. The first piece 250 may be made from a second polymeric material, such as nylon. The second piece 240 includes a recess 242 for receiving at least a portion of the first piece 250 such as the hub 254 of the first piece 250. The first piece 250 may also include a flange 256 for restrictively engaging the end of the indent 242, thereby positioning the first piece 250 with in the second piece 240. In the illustrated embodiment of FIG. 8, the first and second pieces 240, 250 are non-integral.

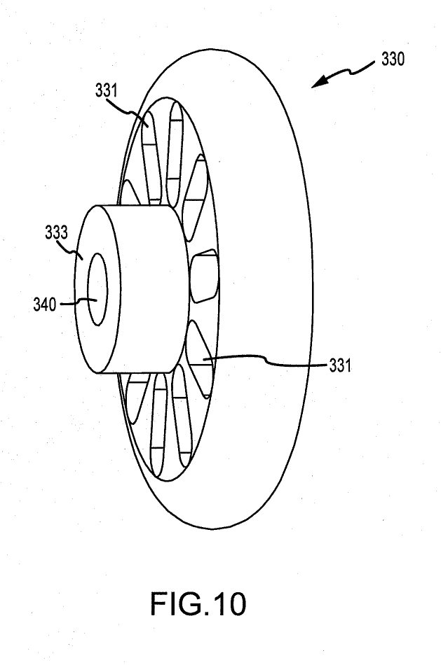

Another embodiment of a roll wheel is illustrated in FIG. 10. In the illustrated embodiment, the roll wheel 330 includes a hub 333 having a passageway 340 for rotatably engaging a shaft. The roll wheel 330 also includes a plurality of apertures 331 extending through the body of the roll wheel 330. These apertures 331 may facilitate low noise emissions by dampening the effects of air movement that may occur during rotation of the roll wheel 330. In the illustrated embodiment, the apertures 331 extend completely through the body of the roll wheel 330. However, in other embodiments, the apertures 331 may only extend partially through the body of the roll wheel 330. Also, while a plurality of apertures 331 are illustrated, only a single aperture may be utilized in some instances.

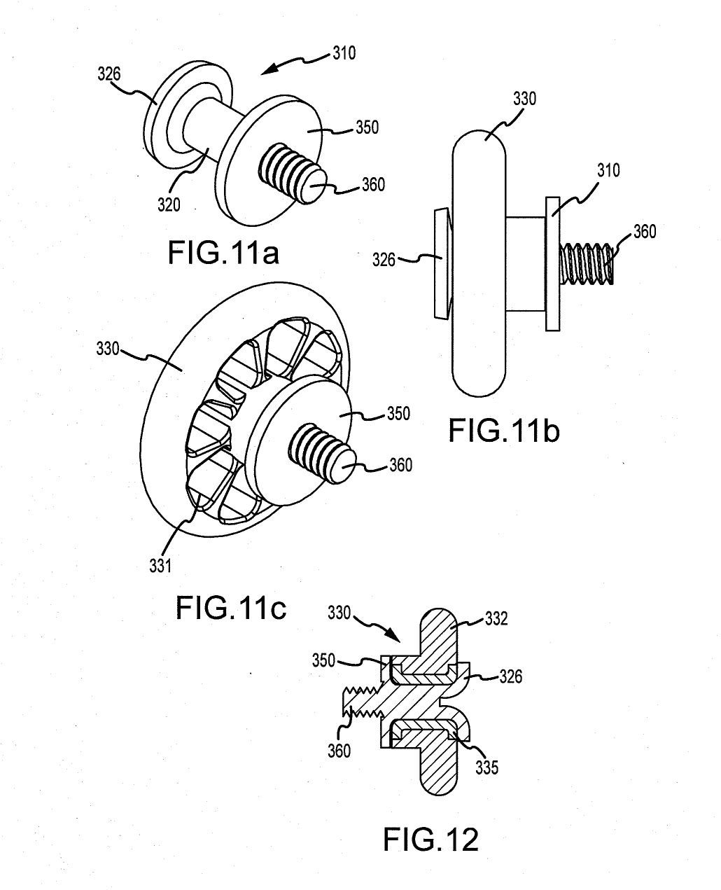

Another embodiment of a roll wheel-shaft arrangement is illustrated in FIGS. 11a through 11c. In the illustrated embodiment, a first piece 310 includes a first flange 326 and a second flange 350. In the illustrated embodiment, the first and second flanges 326, 350 are integral with the shaft 320. In other embodiments, at least one of the first and second flanges 326, 350 may be non-integral with the shaft. The first piece 310 also includes a shaft 320 for rotatably engaging a hub of a roll wheel, such as the hub 333 of roll wheel 330 of FIG. 10. The first and second flanges 326, 350 may restrict side-to-side movement of the roll wheel 330. In the illustrated embodiment, the shaft 320 includes a male member 360, which may engage a female portion of a coupling member, so as to couple the assembly to a shower door mount.

FIG. 12 illustrates an embodiment similar to the embodiment illustrated in FIGS. 11a through 11c but with a multi-piece roll wheel. In this embodiment, the roll wheel 330 includes a first piece 335 and a second piece 332. The first piece 335 may be made from a first polymeric material, and the second piece 332 may be made from a second polymeric material. In this regard, the first piece 335 may be considered an integral bearing molded as part of the substructure of the roll wheel 330 creating a precision concentric roller. A center hub (e.g., hub 333 of FIG. 10) may also act as a bearing surface, which reduces friction and tolerances when having multiple items fitting together.

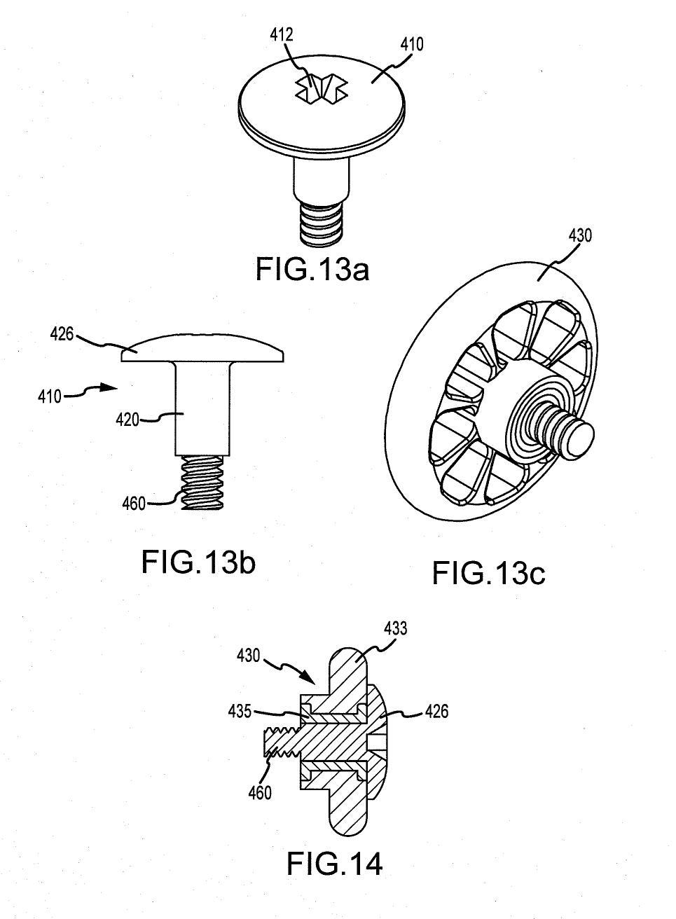

Another embodiment of a roll wheel assembly is illustrated in FIGS. 13a through 13c. In the illustrated embodiment, the assembly includes a roll wheel 430 having a hub, similar to FIG. 10, described above. The first member 410 includes a shaft 420 and a first flange 426. The first member 410 also includes a threaded male coupling member 460 for coupling with a threaded female coupling member, so as to couple the assembly to a shower door mount. The first member 410 also includes indents for facilitating coupling of the first member 410 to the threaded female coupling member.

The roll wheel 430 may also be made of multiple pieces, as illustrated in FIG. 14. In the illustrated embodiment, the roll wheel 430 includes a first piece 435 and a second piece 433. As described above, the first piece 435 may be made of a first polymeric material and the second piece 433 may be made from a second polymeric material. As described above, this facilitates tailored polymeric properties for the hub portion and the tread portion of the roll wheel 430.

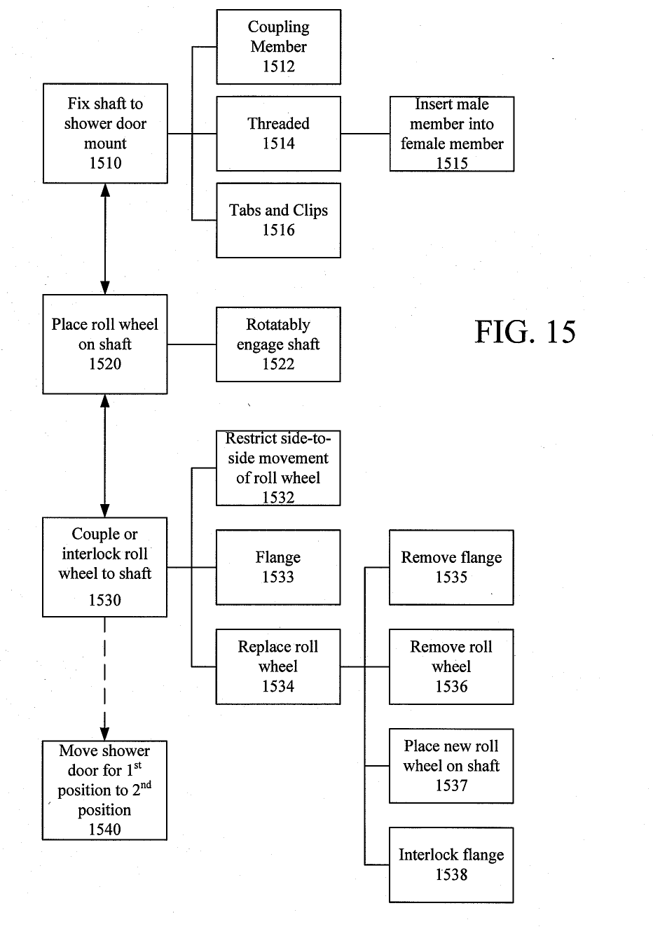

Methods relating to the installation of shower doors utilizing the inventive shower door roll wheel assembly are also provided, one embodiment of which is illustrated in FIG. 15. In the illustrated embodiment, the method includes the steps of fixing a shaft to a shower door mount 1510, placing a roll wheel on the shaft 1520, and coupling or interlocking the roll wheel to the shaft 1530. In one embodiment, the placing step 1520 occurs before the fixing step 1510. In another embodiment, the placing step 1520 occurs after or concomitant to the fixing step 1510. In one embodiment, the coupling or interlocking step 1530 occurs before the fixing step 1510. In one embodiment, the coupling or interlocking step 1530 occurs after or concomitant to the fixing step 1510. Due to the flexibility of the installation steps of the shower door roll wheel assembly, shower door installation may be readily accomplished.

In one embodiment, the fixing step 1510 includes coupling a coupling member 1512 to at least a portion of the shaft. In this regard, after this coupling step, a flange of the coupling member may be located on one side of the shower door mount, and a flange associated with the shaft may be located on a second side of the shower door mount, thus achieving the fixing of the shaft to the shower door mount. In one embodiment, this coupling step includes inserting a threaded male member into a threaded female member 1515. In this regard, the coupling member 1512 may include one of the threaded male member and the threaded female member 1514, and the shaft may include the other of the threaded male member and the threaded female member 1514. In other embodiments, the coupling may be accomplished via other known arrangements, such as a tab and clip arrangement 1516, among others.

As described above, a roll wheel may be placed on a shaft 1520. In one embodiment, the roll wheel and shaft are configured such that the roll wheel rotatably engages the shaft 1520 concomitant to the placing step.

As described above, the method may include the step of coupling or interlocking the roll wheel to the shaft 1530. Concomitant to this coupling or interlocking step 1530, the side-to-side movement of the roll wheel may be restricted 1532. In one embodiment, the coupling or interlocking is accomplished via one or more flanges 1533, such as via any of the above-described flanges.

In some embodiments, the assembly may facilitate replacement of roll wheels. In this regard, a method may include the step of replacing a roll wheel 1534. This replacing roll wheel step 1534 may include the step of removing the flange 1535, removing the roll wheel from the shaft 1536, and placing a new roll wheel on the shaft 1537. The method may also include coupling or interlocking a flange 1538 to the shaft to restrict the side-to-side movement of the new roll wheel. In this regard, the flange may be the originally used flange that was used to couple or interlock the old roll wheel to the shaft, or may be a new flange.

The method may also include the step of moving the shower door from a first position to a second position 1540. In this regard, when the roll wheel comprises at least some soft polymeric material (such as urethane), during the moving step 1540, the portion of the roll wheel that comprises soft polymeric material may absorb energy associated with this moving step 1540, thereby facilitating low noise emissions. In one embodiment, the low noise emissions are perceptibly less than noise emissions of a comparable conventional nylon roll wheel.

While various embodiments of the present invention have been described in detail, it is apparent that modifications and adaptations of those embodiments will occur to those skilled in the art. For example, a precision roller bearing system, such as those used in in-line skates, could be used in the shower door roll wheel assembly of the present disclosure. This modification, and all other such modifications and adaptations, are within the spirit and scope of the present invention.

What is claimed is:

1. An apparatus comprising:
(a) a shower door roll wheel assembly comprising:
(i) a shaft;
(ii) a roll wheel comprising:
(A) a body having a first face and a second face opposite the first face; and
(B) a passageway disposed through the body of the roll wheel;
wherein the roll wheel is configured to rotate about an axis of the passageway; and
wherein the axis of the passageway is transverse to the first face and the second face of the body; and
(C) a tread configured to engage a track of a shower door track;
(iii) a first flange located proximal a first end of the shaft, wherein the first flange is adjacent the first face of the roll wheel;
(iii) a second flange located proximal a second end of the shaft, wherein the second flange is adjacent the second face of the roll wheel;
wherein the first flange is integral with the shaft;
wherein the second flange in non-integral with the shaft, and wherein the second flange is configured to interlock with the second end of the shaft;
wherein, when the roll wheel is located on the shaft and when the second flange is interlocked to the second end of the shaft, the first flange and the second flange restrict side-to-side movement of the roll wheel; and
(b) a coupling member configure to couple the shower door roll wheel assembly to a shower door mount.

2. The apparatus of claim 1, wherein the roll wheel and the shaft are rotatably engaged via the passageway of the roll wheel.

3. The apparatus of claim 1, wherein at least a portion of the passageway of the roll wheel comprise a first polymeric material, wherein at least a portion of the tread of the roll wheel comprises a second polymeric material, wherein the first polymeric material is different than the second polymeric material.

4. The apparatus of claim 3, wherein the first polymeric material comprises a nylon and wherein the second polymeric material comprises a urethane.

5. The apparatus of claim 3, wherein the first polymeric material has a shore hardness that is greater than that of the second polymeric material.

6. The apparatus of claim 1, wherein the second flange may be repeatedly interlocked to and disengaged from the second end of the shaft.

7. The apparatus of claim 1, wherein the coupling member is configured to couple the shower door roll wheel assembly to the shower door mount via the shaft.

8. The apparatus of claim 7, wherein the shaft comprises one of a male fitting and female fitting, wherein the coupling member comprises the other of the male fitting and the female fitting, and wherein the coupling member is configured to couple the shower door roll wheel assembly to the shower door mount via interconnection of the male fitting to the female fitting.

9. The apparatus of claim 8, wherein the male fitting and the female fitting are threaded.

10. The apparatus of claim 1, wherein the roll wheel comprises a first piece and a second piece, wherein the first piece comprises at least a portion of the passageway, and wherein the second piece comprises at least a portion of the tread.

11. The apparatus of claim 10, wherein the first piece comprises a first polymeric material, wherein the second piece comprises a second polymeric material, and wherein the second polymeric material is different than the first polymeric material.

12. The apparatus of claim 10, wherein the first piece is a ring-shaped solid, wherein the inner surface of the ring-shaped solid comprises the passageway of the roll wheel, and wherein at least one tab extends from an outer surface of the ring-shaped solid.

13. The apparatus of claim 12, wherein the at least one tab is located proximal an end portion of the ring-shaped solid.

14. The apparatus of claim 13, wherein the second piece comprises at least one slot, wherein each slot of the second piece is configured to restrictively engage each tab of the first piece.

15. The apparatus of claim 14, wherein, the first face of the roll wheel comprises an extension, and wherein the extension includes at least a portion of a tab of the first piece.

16. The apparatus of claim 11, wherein the first piece and the second piece are integral.

17. An apparatus comprising:
(a) a shower door roll wheel assembly comprising:
(i) a shaft having a first end;
(ii) a roll wheel comprising:
(A) a body having a first face, wherein the first face is proximal the first end of the shaft; and
(B) a passageway disposed through the body of the roll wheel;
wherein the roll wheel is configured to rotate about an axis of the passageway; and
wherein the axis of the passageway is transverse to the first face of the body; and
(C) a tread configured to engage a track of a shower door track;
(iii) a first flange coupled to the first end of the shaft, wherein the first flange is adjacent the first face of the roll wheel;
(b) a coupling member configure to couple the shower door roll wheel assembly to a shower door mount;
wherein, when the shower door roll wheel assembly is coupled to the coupling member and when the first flange is coupled to the second end of the shaft, the first flange and a side of the shower door mount restrict side-to-side movement of the roll wheel.

18. A method for installing a shower door comprising:
(a) fixing a shaft to a shower door mount;
(b) placing a roll wheel on the shaft; and
(c) interlocking the roll wheel to the shaft;
wherein, after the interlocking step, a passageway of the roll wheel rotatably engages the shaft and side-to-side movement of the roll wheel is restricted.

19. The method of claim 18, wherein both the placing step and the interlocking step occur before the fixing step.

20. The method of claim 18, wherein the fixing step comprises:
coupling a coupling member to at least a portion of the shaft;
wherein, after the coupling, a face of the coupling member is located on a first side of the shower door mount and a flange associated with the shaft is located on a second side of the shower door mount.

21. The method of claim 18, wherein the interlocking step comprises:
interlocking a flange to an end of the shaft.

22. The method of claim 18, wherein at least a portion of the roll wheel comprises urethane, the method comprising:
moving a shower door associated with the shower door mount from a first position to a second position;
wherein, during the moving step, the portion of the roll wheel comprising urethane absorbs energy associated with the moving step, thereby facilitating low noise emissions.

23. The method of claim 22, wherein the low noise emissions are perceptibly less than the noise emissions of a comparable conventional nylon roll wheel.
